(19) United States
(12) Patent Application Publication
(10) Pub. No.: US 2011/0242096 A1
(43) Pub. Date: Oct. 6, 2011

(54) ANATOMY DIAGRAM GENERATION METHOD AND APPARATUS, AND MEDIUM STORING PROGRAM

(75) Inventor: Yoshiro KITAMURA, Tokyo (JP)

(73) Assignee: FUJIFILM CORPORATION, Tokyo (JP)

(21) Appl. No.: 13/013,389

(22) Filed: Jan. 25, 2011

(30) Foreign Application Priority Data
Mar. 31, 2010 (JP) 2010-081105

(51) Int. Cl. G06T 17/00

(52) U.S. Cl. 345/419

(57) ABSTRACT

A storage unit stores a multiplicity of keywords to be extracted from medical treatment reports, each of the multiplicity of keywords representing a region of a human body, a disease name, or a treatment method, and an image generation condition for volume rendering appropriate for the region or the like in such a manner that each of the multiplicity of keywords and the image generation condition are correlated with each other. An extraction unit extracts, from a medical treatment report, at least one of the multiplicity of keywords representing a region of a human body, a disease name, or a treatment method. An image generation unit generates an anatomy diagram by performing volume rendering on a three-dimensional image representing a three-dimensional human body model by using the image generation condition correlated with the at least one of the multiplicity of keywords.

### BACKGROUND OF THE INVENTION

1. Field of the Invention

The present invention relates to an anatomy diagram generation method and apparatus for generating an anatomy diagram from a three-dimensional human body model. Further, the present invention relates to a non-transitory computer-readable medium storing therein a program for causing a computer to execute processing for generating an anatomy diagram.

2. Description of the Related Art

Conventionally, in medical fields, an anatomy diagram showing the same region as a region of a human body included in a medical image of a patient obtained by radiography is placed next to the medical image of the patient and viewed, in some cases, so as to more accurately read and interpret the medical image, or to explain conditions and a treatment method to the patient in such a manner that the patient can easily understand the explanation.

U.S. Patent Application Publication No. 20090245609 (Patent Document 1) proposes a technique of preparing many anatomy diagrams, each showing a region of a human body, such as a head, an abdomen, and a heart, in advance. In the technique of Patent Document 1, image analysis is performed on an input medical image to identify a region included in the medical image. Further, an anatomy diagram that shows the same region as the region included in the medical image is selected from many anatomy diagrams, and provided.

However, even when image diagnosis (diagnosis using images) is performed by using a medical image including the same region, anatomy diagrams that are appropriate for observation and understanding of medical images are different in some cases, depending on a position at which abnormality is present. For example, when image diagnosis is performed by using an image including a heart, if an aortic valve is abnormal, an anatomy diagram showing a heart in such a manner that a part of the heart is removed to observably expose the aortic valve and that the aortic valve is viewed from the removed side of the heart should be displayed. However, if a coronary artery is abnormal, an anatomy diagram showing the entire heart including the coronary artery and the aortic valve in such a manner that the entire heart is viewed from the front side of the human body should be displayed. Similarly, anatomy diagrams that are appropriate for observation and understanding of medical images differ, in some cases, depending on the kinds of abnormality, treatment methods to be applied, and the like.

Further, a human body is an aggregate of extremely many organs that three-dimensionally overlap with each other in many layers. Therefore, when a three-dimensional structure of a specific organ or a positional relationship between the organ and tissue surrounding the organ needs to be observed, if even a small portion of tissue that a doctor does not have interest is displayed, observation by the doctor is disturbed. However, since the number of organs of a human body is extremely large, it is actually impossible to prepare anatomy diagrams for each organ and for each case.

However, in Patent Document 1, when the same region is included in input medical images, the same anatomy diagram is provided. Specifically, Patent Document 1 does not provide a customized anatomy diagram based on a position at which abnormality is present in the region, the kind of abnormality, a treatment method to be applied, or the like.

### SUMMARY OF THE INVENTION

In view of the foregoing circumstances, it is an object of the present invention to provide an anatomy diagram generation method and apparatus that can automatically generate and provide an anatomy diagram (anatomical chart) that is appropriate for observation and understanding of a diagnosis result and a treatment method. Further, it is another object of the present invention to provide a non-transitory computer-readable medium storing therein a program for causing a computer to execute processing for generating an anatomy diagram.

An anatomy diagram generation method of the present invention is an anatomy diagram generation method comprising the steps of:

storing a multiplicity of keywords to be extracted from reports related to medical treatment, each of the multiplicity of keywords representing a region of a human body, a disease name, or a treatment method, and an image generation condition for volume rendering that is appropriate for the region of the human body, the disease name, or the treatment, which is represented by each of the multiplicity of keywords, in such a mariner that each of the multiplicity of keywords and the image generation condition are correlated with each other;

extracting, from a report related to medical treatment of a patient, at least one of the multiplicity of keywords representing a region of a human body, a disease name, or a treatment method; and

generating an anatomy diagram by performing volume rendering on a three-dimensional image representing a three-dimensional human body model by using the image generation condition correlated with the at least one of the multiplicity of keywords, which has been extracted.

Here, the report is a diagnosis result of a patient or the like that has been electronically recorded, and the report is electronically readable. The report includes at least one of text data, voice data and image data. One of examples of the report is an image interpretation report in which a result of diagnostic interpretation of a medical image is recorded.

The keyword is information that is necessary to determine the kind of an anatomy diagram, an angle (a viewpoint, or the like) and the like that are appropriate to understand the diagnosis result, the treatment method, and the like.

Further, the image generation condition is a condition, such as the position of a viewpoint and the opacity of each voxel, that is necessary to perform volume rendering. The image generation condition is not limited to these conditions, but a concept including at least one of conditions for customizing a part of the conditions that have been set in advance as standard conditions, and which are necessary for performing volume rendering.

Further, the anatomy diagram is an image in which the form (shape) and the structure of a living organism are drawn.

An anatomy diagram generation apparatus of the present invention is an anatomy diagram generation apparatus comprising:

a storage unit that stores a multiplicity of keywords to be extracted from reports related to medical treatment, each of the multiplicity of keywords representing a region of a human body, a disease name, or a treatment method, and an image generation condition for volume rendering that is appropriate for the region of the human body, the disease name, or the treatment, which is represented by each of the multiplicity of keywords, in such a manner that each of the multiplicity of keywords and the image generation condition are correlated with each other;

an extraction unit that extracts, from a report related to medical treatment of a patient, at least one of the multiplicity of keywords representing a region of a human body, a disease name, or a treatment method; and

an image generation unit that obtains, from the storage unit, the image generation condition correlated with the at least one of the multiplicity of keywords extracted by the extraction unit, and generates an anatomy diagram by performing volume rendering on a three-dimensional image representing a three-dimensional human body model by using the obtained image generation condition.

In the anatomy diagram generation method and apparatus, the image generation condition may include a range of volume rendering in the three-dimensional image and a viewpoint at the time of volume rendering.

Further, a line diagram may be generated from the generated anatomy diagram.

The range of volume rendering may include a target region corresponding to the region of the human body, the disease name or the treatment method represented by the at least one of the multiplicity of keywords, which has been extracted, and a surrounding region that is other than the target region. Further, the volume rendering maybe performed in such a manner that the opacity of the surrounding region is lower than the opacity of the target region.

Further, a non-transitory computer-readable medium of the present invention stores therein a program for causing a computer to execute processing for generating an anatomy diagram.

According to the anatomy diagram generation method and apparatus, and the non-transitory computer-readable medium of the present invention, a multiplicity of keywords to be extracted from reports related to medical treatment, each of the multiplicity of keywords representing a region of a human body, a disease name, or a treatment method, and an image generation condition for volume rendering that is appropriate for the region of the human body, the disease name, or the treatment, which is represented by each of the multiplicity of keywords, are stored. Further, each of the multiplicity of keywords and the image generation condition are correlated with each other. Further, at least one of the multiplicity of keywords representing a region of a human body, a disease name, or a treatment method is extracted from a report related to medical treatment of a patient. Further, an anatomy diagram is generated by performing volume rendering on a three-dimensional image representing a three-dimensional human body model by using the image generation condition correlated with the at least one of the multiplicity of keywords, which has been extracted. Therefore, it is possible to automatically generate an anatomy diagram based on a region of a human body that is a target of interpretation (reading) in a medical image, a disease name and a treatment method. Consequently, it is possible to automatically provide an anatomy diagram that is appropriate for observation and understanding of the medical image.

In the method, apparatus, and non-transitory computer-readable medium, when the image generation condition includes a range of volume rendering in the three-dimensional image and a viewpoint at the time of volume rendering, it is possible to generate and provide an anatomy diagram showing a region of a human body based on information, such as a region of a human body that is a target of interpretation in a medical image, a disease name, and a treatment method, in such a manner that the region of the human body is viewed from a viewpoint appropriate for observation of the region.

When a line diagram is generated from the generated anatomy diagram, it is also possible to automatically generate and provide a line diagram based on information, such as a region of a human body that is a target of interpretation in a medical image, a disease name, and a treatment method.

Further, when the range of volume rendering includes a target region corresponding to the region of the human body, the disease name or the treatment method represented by the at least one of the multiplicity of keywords, which has been extracted, and a surrounding region that is other than the target region, and the volume rendering is performed in such a manner that the opacity of the surrounding region is lower than the opacity of the target region, it is possible to generate and provide an anatomy diagram that displays the target region more clearly and sharply than a surrounding region of the target region, while the surrounding region is displayed together with the target region. Accordingly, an observer can easily recognize the position and the range of the target region.

Note that the program of the present invention may be provided being recorded on a computer-readable medium. Those who are skilled in the art would know that computer-readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a medical image diagnosis system;

FIG. 2 is a diagram illustrating the hardware configuration of an anatomy diagram generation apparatus illustrated in FIG. 1;

FIG. 3 is a function block diagram of the anatomy diagram generation apparatus illustrated in FIG. 1;

FIG. 4 is a diagram illustrating an example of an image interpretation report;

FIG. 5 is a diagram for explaining generation of an anatomy diagram by volume rendering;

FIG. 6A is a diagram illustrating an example of a generated anatomy diagram;

FIG. 6B is a diagram illustrating an example of a generated anatomy diagram; and

FIG. 6C is a diagram illustrating an example of a generated anatomy diagram.

### DESCRIPTION OF THE PREFERRED EMBODIMENTS

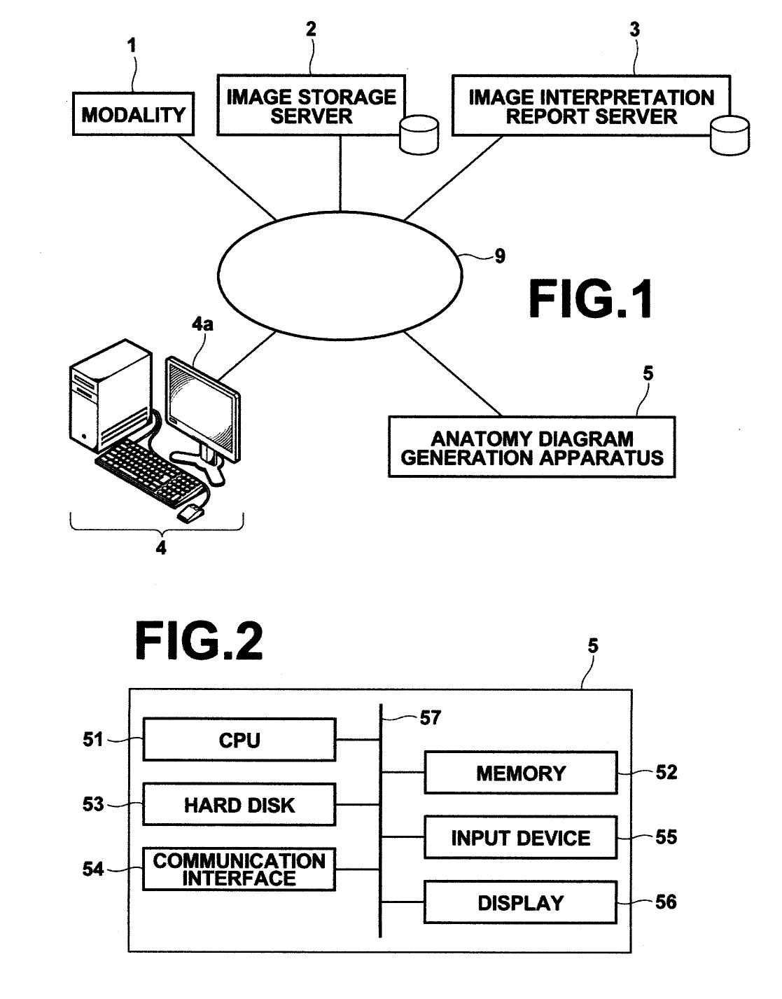

Hereinafter, a medical image diagnosis system into which an anatomy diagram generation apparatus according to an embodiment of the present invention has been introduced will be described. FIG. 1 is a schematic diagram illustrating the configuration of the medical image diagnosis system. As illustrated in FIG. 1, a modality 1, an image storage server 2, an image interpretation report server 3, an image processing workstation 4, and an anatomy diagram generation apparatus 5 are connected to each other through a network 9 in this system in such a manner that they can communicate with each other.

The modality 1 includes an apparatus that generates image data of a three-dimensional medical image representing an examination target region of a subject by performing radiography on the region, and that outputs, as image information, the image data after attaching supplementary information defined by DICOM (Digital Imaging and Communication in Medicine) standard to the image data. Examples of the modality 1 are a CT, an MRI, and the like.

The image storage server 2 is a computer that stores the image data of the medical image obtained by the modality 1 in an image database, and that manages the image data stored in the image database. The image storage server 2 searches, based on a view request from the image processing workstation 4, the database to extract image data, and sends the extracted image data to the image processing workstation 4, which originated the request. The format of storing image data and communication between the apparatuses through the network 9 are based on a protocol, such as DICOM.

The image interpretation report server 3 is a computer that stores, in a database, data of the image interpretation report generated at the image processing workstation 4, and that manages the data of the image interpretation report stored in the database. The image interpretation report server 3 searches, based on a view request from the image processing workstation 4 or the anatomy diagram image generation apparatus 5, the database to extract data of an image interpretation report, and sends the extracted data of the image interpretation report to the originator (sender) of the request.

The image processing workstation 4 is a computer including known hardware elements, such as a CPU, a memory, a hard disk, an input/output (I/O) interface, a communication interface, an input device (a pointing device, a keyboard, or the like), a display 4a, and a data bus. In the image processing workstation 4, a known operating system, application software, or the like is installed. As the application software, an image search/obtainment application for obtaining medical image data from the image storage server 2, an image interpretation report application for generating and editing an image interpretation report or the like, an anatomy diagram obtainment application for obtaining an anatomy diagram from the anatomy diagram generation apparatus 5, and the like are installed. When these kinds of application software are executed, each of the aforementioned processing is executed at the image processing workstation 4.

The image processing workstation 4 displays an image interpretation report generation screen on a display 4a while the image interpretation report application is executed. Further, the image processing workstation 4 generates an electronic image interpretation report about a medical image based on an input operation by a user at the image interpretation report generation screen. The data of the generated image interpretation report are stored in a hard disk at the image processing workstation 4 or a database in the image interpretation report server 3, and managed.

Here, the image interpretation report includes at least one of text data, vice data and image data. FIG. 4 is a diagram illustrating an example of an image interpretation report generated at the image processing workstation 4. An image interpretation report 100 illustrated in FIG. 4 includes a patient information box 110, a findings box 120, a voice findings box (oral findings box) 130, and an attached image box 140. A patient name, a patient ID (identification) number and the like are written in the patient information box 110. Findings by a doctor or the like who interpreted a target image of interpretation are written in the findings box 120. Further, a link to voice data in which oral findings by the doctor or the like who interpreted the image are recorded is inserted in the voice findings box 130. Further, an attached image 141, such as an image in which a condition noted in the findings appears and a reference image, is inserted in the attached image box 140. When a play button 130a is selected, the recorded voice is played (reproduced).

Further, the image processing workstation 4 sends, based on an instruction by a user, a request for an anatomy diagram to the anatomy diagram generation apparatus 5, while the anatomy diagram obtainment application is executed. Further, the image processing workstation 4 displays, at the display 4a, the anatomy diagram sent from the anatomy diagram generation apparatus 5. Here, the request for an anatomy diagram includes the file name of a medical image to be compared with, the file name of an image interpretation report related to the medical image to be compared with, information, such as a patient ID, for identifying an image interpretation report, or the like. Alternatively, the request for an anatomy diagram may include the image interpretation report, instead of the information for identifying the image interpretation report.

As illustrated in FIG. 2, the anatomy diagram generation apparatus 5 is a computer including known hardware elements, such as a CPU 51, a memory 52, a hard disk 53, a communication interface 54, an input device 55 (a pointing device, a keyboard, and the like), a display 56, and a data bus 57. A known operating system, an application (anatomy diagram generation program) for performing anatomy diagram generation processing of the present invention, and the like are installed in the anatomy diagram generation apparatus 5. The anatomy diagram generation program is stored in the memory 52. When the CPU 51 executes the anatomy diagram generation program, anatomy diagram generation processing according to the embodiment of the present invention is performed in the anatomy diagram generation apparatus 5. The application software, such as the anatomy diagram generation program, may be installed from a recording medium, such as a CD-ROM. Alternatively, the application software may be downloaded from a storage apparatus of a server connected to the anatomy diagram generation apparatus 5 through a network, such as the Internet, and installed in the anatomy diagram generation apparatus 5.

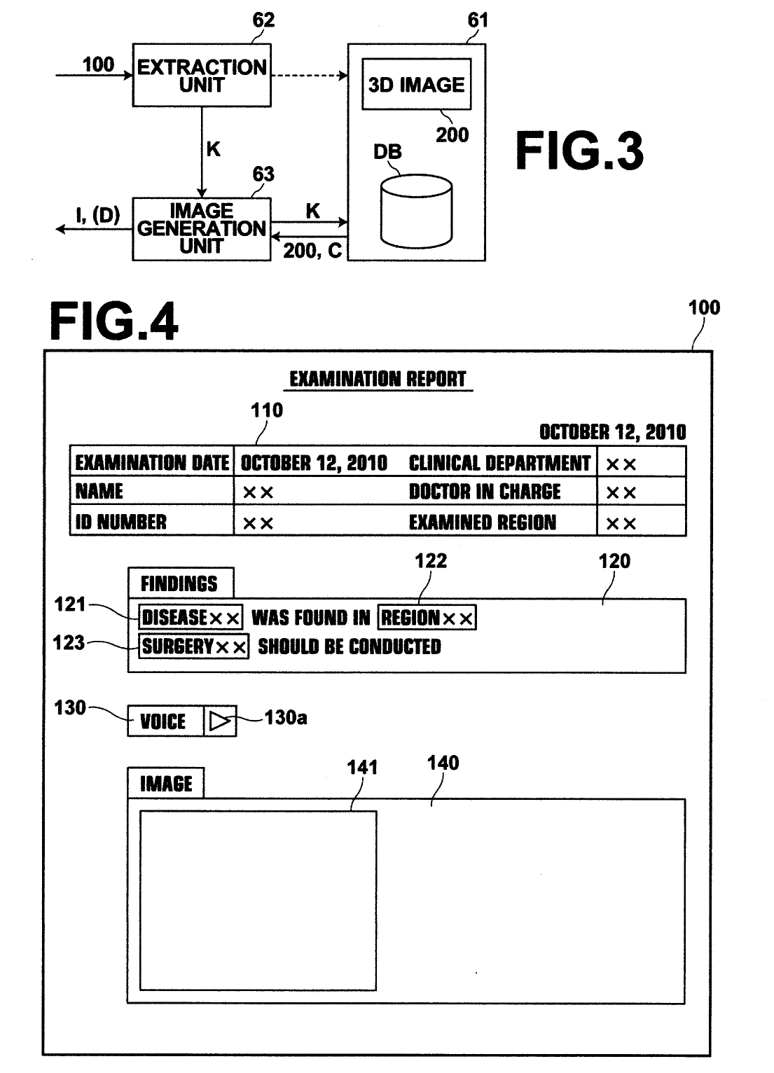

As illustrated in FIG. 3, a three-dimensional image 200 representing a three-dimensional human body model in a normal state (healthy state) is stored in the hard disk 53. The three-dimensional image 200 is composed of voxels that are arranged in three-dimensional coordinate space. The position of each voxel is defined in a three-dimensional coordinate system, which is represented by x axis, y axis and z axis. The x axis represents the left/right direction of a human body, and the y axis represents the anterior/posterior direction of the human body. Further, the z axis represents the superior/inferior direction of the human body. The voxel value of each voxel is correlated with the coordinate of the position of the voxel.

In the hard disk 4, database DB is structured, and many keywords and image generation conditions for volume rendering are registered in the database DB. Each of many keywords represents a region of a human body, a disease name, or a treatment method to be extracted from an image interpretation report related to a medical image (hereinafter, “a region of a human body, a disease name, or a treatment method” will be referred to as “a region or the like”). In the database DB, an image generation condition that is appropriate for a region or the like represented by each of the keywords is correlated with the keywords. Therefore, it is possible to easily search, based on a keyword representing a region or the like, and which has been extracted from the image interpretation report, the database DB for an image generation condition for volume rendering that is appropriate for the region or the like represented by the keyword, and to obtain the image generation condition.

When plural keywords are extracted, an image generation condition is set in such a manner that all of anatomical regions correlated with the keywords are displayed. Therefore, even if a limited number of keywords are prepared in advance, it is possible to provide various kinds of many anatomy diagrams by using the keywords in combination. At this time, an image generation range is adjusted so that all of the anatomical regions are located within a display range.

In addition to registering various keywords in the database DB in such a manner that each of the keywords is correlated with an image generation condition, it is possible to register an image generation condition for a combination of two or more keywords. Consequently, it is possible to search the database for an optimum image generation condition for a combination of two or more keywords, and to obtain the optimum image generation condition.

Here, many keywords and image generation conditions correlated with the keywords are registered in advance. The keywords and the image generation conditions may be registered by an input at the input device 55. Alternatively, data of “correspondence between keywords and image generation conditions” that are prepared in advance may be copied through a network, a recording medium or the like, and registered.

The keyword representing a region or the like, which is registered, includes at least one of the name of the region or the like, another name or a sign representing the region or the like, and abbreviations thereof. Specifically, aorta, ascending aorta, aortic valve, mitral valve, coronary arteries, right coronary artery, left anterior descending branch, left circumflex branch, pulmonary artery, interatrial septum, interventricular septum and the like may be used as the keywords representing regions. Further, aortic stenosis, aortic insufficiency (aortic incompetence), mitral stenosis, mitral insufficiency (mitral incompetence), coronary artery stenosis, aortic aneurysm, patent ductus arteriosus, pulmonary stenosis, atrial septal defect, ventricular septal defect, and the like may be used as the keywords representing disease names. Further, bypass operation, colectomy, Batista operation, and the like may be used as the keywords representing treatment methods.

The image generation condition includes a range of volume rendering in the three-dimensional image 200, the opacity of each voxel within the range, a viewpoint at the time of volume rendering, and the like. An image range in the three-dimensional image 200 is stored as a range of volume rendering, for example, in such a manner that an image range in which the heart, a part of which has been removed so that the aortic valve is observable, is located is correlated with the keyword of aortic stenosis or aortic insufficiency.

Further, an image range in which the heart, a part of which has been removed so that the mitral valve is observable, is located may be correlated with the keyword of mitral stenosis or mitral insufficiency, and stored as a range of volume rendering. The whole heart including the coronary arteries corresponding to a stenosis region and the aorta may be correlated with the keyword of coronary artery stenosis (stenosis region), and stored as a range of volume rendering. Further, the whole aorta may be correlated with the keyword of aortic aneurysm, and stored as a range of volume rendering. Further, a part of the aorta in the vicinity of the ascending aorta, a part of the aorta in the vicinity of the aortic arch, a part of the aorta in the vicinity of the descending aorta, and a part of the aorta in the vicinity of abdominal aorta may be correlated with the keywords of ascending aortic aneurysm, aortic arch aneurysm, descending aortic aneurysm, and abdominal aortic aneurysm of the aortic aneurysm, respectively, and stored as ranges of volume rendering.

When the opacity of each voxel in the range of volume rendering is set as an image generation condition, if the range of volume rendering includes a target region, which corresponds to a region or the like, and a surrounding region (peripheral region) of the target region, which is not the target region, the opacity of the surrounding region may be set lower than the opacity of the target region. Accordingly, it is possible to generate and to provide an anatomy diagram in which the surrounding region is displayed together with the target region in such a manner that the target region is displayed more clearly and sharply than the surrounding region.

FIG. 2 is a block diagram illustrating a part of the functions of the anatomy diagram generation apparatus 5. FIG. 2 illustrates a part related to generation of an anatomy diagram according to an embodiment of the present invention. As illustrated in FIG. 2, in the anatomy diagram generation processing of the present invention, an anatomy diagram is generated from a three-dimensional human body model by a request at the image processing workstation 4, and provided. The anatomy diagram generation processing is realized by a storage unit 61, an extraction unit 62, and an image generation unit 63.

The storage unit 61 is constituted of a hard disk 53. The storage unit 61 stores the three-dimensional image 200 representing a three-dimensional human body model, as described above. Further, the storage unit 61 stores database DB, in which many keywords and image generation conditions for volume rendering are registered. Each of many keywords represents a region or the like, and the keywords are to be extracted from image interpretation reports related to medical images. In the database DB, an image generation condition that is appropriate for a region of a human body, a disease name or a treatment method represented by each of the keywords is correlated with the keywords. Therefore, when keyword K representing a region or the like is input from the image generation unit 63, the storage unit 61 extracts, from the database DB, image generation condition C correlated with the keyword K, and outputs the image generation condition C to the image generation unit 63. Further, the storage unit 61 provides a three-dimensional image 200 based on a request from the image generation unit 63.

First, the extraction unit 62 receives a request for an anatomy diagram from the image processing workstation 4. As described above, the request for an anatomy diagram includes information for identifying an image interpretation report, or the image interpretation report 100. When the request for an anatomy diagram includes the image interpretation report 100, the extraction unit 62 extracts at least one keyword representing a region or the like from the image interpretation report 100. When the request for an anatomy diagram includes information for identifying an image interpretation report, the extraction unit 62 sends the information to the image processing workstation 4 or to the image interpretation report server 3 to request transfer of the image interpretation report. Further, the extraction unit 62 extracts at least one keyword representing a region or the like from the transferred image interpretation report 100.

As described above, the image interpretation report 100 includes at least one of text data, voice data and image data. The extraction unit 62 extracts a keyword from at least one of the text data, the voice data and the image data included in the image interpretation report 100 by detecting the keyword that is the same as a keyword stored in the database DB of the storage unit 61.

When a keyword is extracted from the voice data in the image interpretation report 100, the recorded voice data should be converted into text data by using a known voice recognition technique, and a keyword that is the same as a keyword stored in the database DB should be detected in the text data. When a keyword is extracted from the image data in the image interpretation report 100, text data should be obtained by performing image analysis on the image data by using a known region recognition technique, a CAD (computer-aided diagnosis) system, or the like. Further, a keyword that is the same as a keyword stored in the database DB should be extracted from the obtained text data.

The image generation unit 63 obtains, from the storage unit 61, image generation condition C corresponding to keyword K extracted by the extraction unit 62. Further, the image generation unit 63 generates anatomy diagram I by performing volume rendering on three-dimensional image 200 by using the obtained image generation condition C. The image generation unit 63 may set, in advance, a standard condition that is generally applied to each of all items of image generation conditions that are necessary to generate the anatomy diagram I. Further, the image generation unit 63 may customize the set standard conditions by changing a part or all of the standard conditions based on the image generation condition C obtained from the storage unit 61. The image generation condition C obtained from the storage unit 61 includes a range 210 of volume rendering in the three-dimensional image 200, the opacity of each voxel in the range 210, viewpoint E at the time of volume rendering, and the like, as described above.

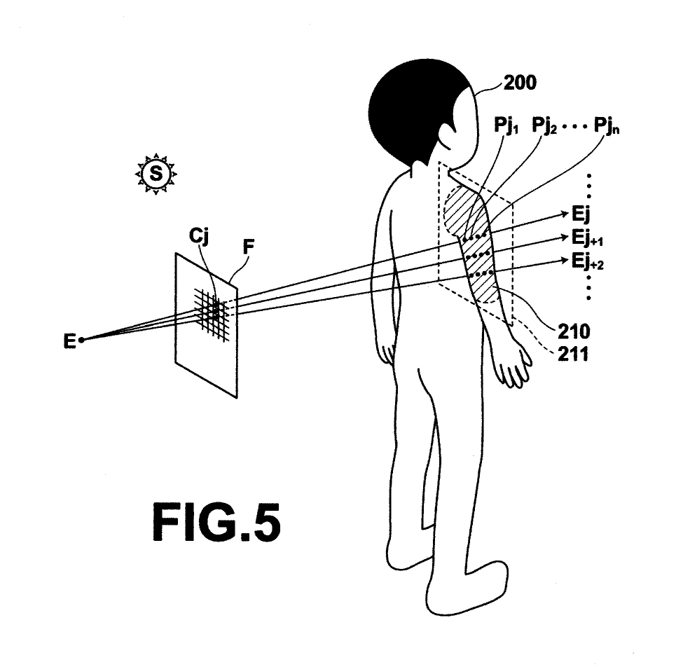

Next, with reference to FIG. 5, processing for generating an anatomy diagram by volume rendering will be described. Here, a case in which a keyword related to the posterior surface (posterior side) of the right brachium (upper arm) is extracted from an image interpretation report will be described. Further, in this example, image generation condition C obtained from the storage unit 61 includes, as the range 210 of volume rendering, an image range in which the right brachium is located in the three-dimensional image 200. Further, the image generation condition C includes, as viewpoint E at the time of volume rendering, a predetermined position on the posterior side of the right brachium. Further, the range 211 of visual field at the time of volume rendering that defines the position and the size of projection plane F substantially encloses the range 210 of volume rendering.

First, sampling is performed on the range 210 based on set viewpoint E, light source S and projection plane F. Sampling is performed at predetermined intervals along a plurality of visual lines Eⱼ (j=1, 2, . . . , m; m is the number of visual lines) connecting the viewpoint E and each projection pixel on the projection plane F to obtain a plurality of exploration points Pⱼᵢ (i=1, 2, . . . , n; n is the number of exploration points on visual line Eⱼ). The plurality of exploration points Pⱼᵢ are set. Next, the intensity value (luminance, brightness) b(Pⱼᵢ) and the opacity α(Pⱼᵢ) at each of the exploration points Pⱼᵢ are obtained along each of the visual line Eⱼ. Then, as shown in the following formula (1), the product of the intensity value and the opacity at each of the exploration points Pⱼᵢ is added:

$$\begin{matrix}[ Formula 1 ] & \\ {C}_{j} = {\sum }_{i = 1}^{n} ( b ( {P}_{ji} ) \times ∝ ( {P}_{ji} ) {\prod }_{k = 1}^{i - 1} ( 1 - ∝ ( {P}_{jk} ) ) ) . & ( 1 ) \end{matrix}$$

When the cumulative value of the opacity α reaches a predetermined threshold value, or a ray goes out of three-dimensional medical image V, which is the target of the ray, processing for the visual line Eⱼ is finished. Further, the result of addition is determined as output pixel value Cⱼ of a projection pixel on the projection plane F at which the visual line Eⱼ passes through the projection plane F.

This processing is performed for each visual line, and an output pixel value is determined for each of all projection pixels on the projection plane F. Accordingly, a volume rendering image, in other words, anatomy diagram I is generated. The generated anatomy diagram I is output to the image processing workstation 4.

The opacity α(Pⱼᵢ) of each of the exploration points Pⱼᵢ is determined based on the opacity that has been provided for each tissue of the three-dimensional human body model in advance. Further, the intensity value b(Pⱼᵢ) is calculated by using the following formula (2):

[Formula 2]

b(Pⱼᵢ)=h(N(Pⱼᵢ)·L)×c(Pⱼᵢ) (2).

Here, h represents a shading function by diffuse reflection. N(Pⱼᵢ) represents a normal vector at each exploration point Pⱼᵢ. L represents a unit direction vector from exploration point Pⱼᵢ to light source S. The sign “·” represents the inner product of vectors. Further, c(Pⱼᵢ) represents color information that is assigned based on color information defined in advance for each tissue of a subject to be examined.

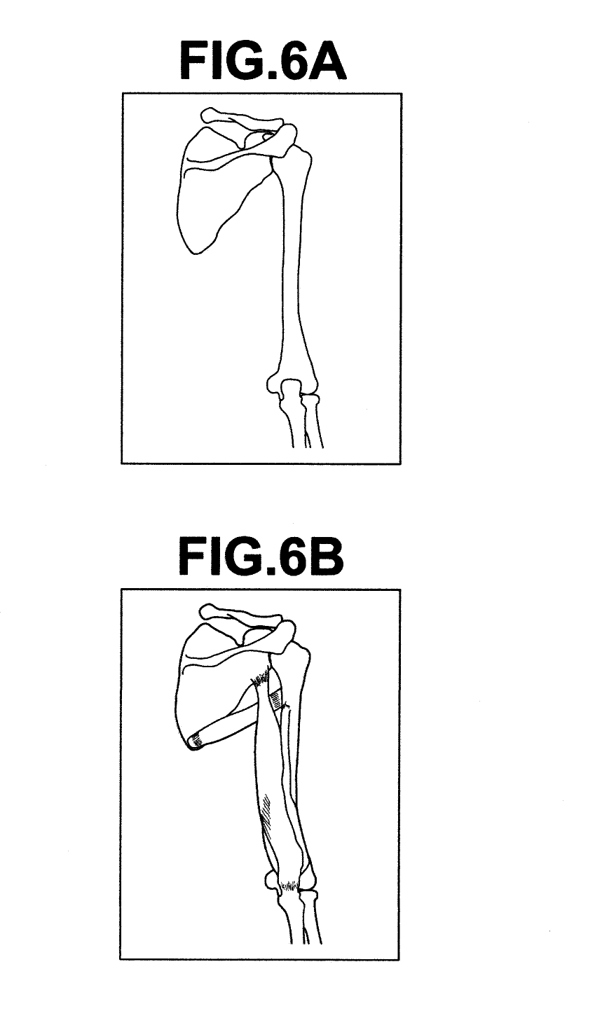

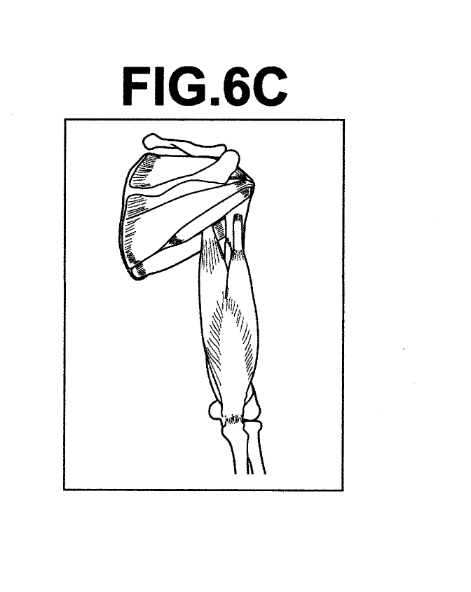

FIGS. 6A through 6C are examples of anatomy diagrams generated by the anatomy diagram generation processing of the present invention. All of FIGS. 6A through 6C are anatomy diagrams of the posterior side of the same right brachium. However, in each of FIGS. 6A through 6C, the range of volume rendering is customized based on the variation of a keyword or keywords extracted from the image interpretation report 100.

Specifically, in the examples illustrated in FIG. 6A through 6C, the database DB in the storage unit 61 stores, as ranges of volume rendering, clavicle (collar bone), scapula (shoulder blade bone), humerus, and upper ends of ulna and radius for the keyword of humerus. The database DB stores clavicle, scapula, humerus, and upper ends of ulna and radius, teres major (muscle), long head of triceps brachii (muscle), and medial head of triceps brachii for the keyword of long head of triceps brachii. Further, the database stores clavicle, scapula, humerus, and upper ends of ulna and radius, teres major, long head of triceps brachii, and medial head of triceps brachii, supraspinous (muscle), infraspinatus (muscle), teres minor (muscle), and lateral head of triceps brachii for the keyword of infraspinatus (muscle). These regions, as the ranges of volume rendering, are correlated with the keywords. When data are stored in the database DB in such a manner, FIG. 6A is a diagram illustrating an anatomy diagram generated when the extraction unit 62 extracts, as keyword K, humerus. FIG. 6B is a diagram illustrating an anatomy diagram generated when the extraction unit 62 extracts, as keyword K, long head of triceps brachii. FIG. 6C is a diagram illustrating an anatomy diagram generated when the extraction unit 62 extracts, as keyword K, infraspinatus.

Further, the image generation unit 63 may generate line diagram D (schema (schema diagram), or the like) based on the generated anatomy diagram I. The image generation unit 63 outputs the generated line diagram D to the image processing workstation 4. Here, the line diagram D is generated, for example, by extracting outlines from the anatomical diagram I by using a known outline extraction technique.

The line diagram D may be generated from the anatomy diagram I generated by the image generation unit 63. Alternatively, the line diagram D may be generated directly from the three-dimensional image 200. In that case, line diagram generation conditions for generating a line diagram that is appropriate for a region of a human body, a disease name or a treatment method represented by a keyword are stored in the storage unit 61 in advance for each of many keywords representing a region or the like to be extracted from image interpretation reports related to medical images. The line diagram generation conditions are stored in such a manner to be correlated with the keywords. When the extraction unit 62 extracts keyword K, a line diagram generation condition corresponding to the keyword K should be obtained from the storage unit 61. Further, line diagram D should be generated from the three-dimensional image 200 by using the obtained line diagram generation condition.

Further, the image generation unit 63 may generate an image in which the name of each region included in the generated anatomy diagram I or line diagram D is inserted, and output the generated image to the image processing workstation 4.

In the above embodiment, the anatomy diagram generation apparatus of the present invention is applied to generation of an anatomy diagram from a three-dimensional human body model by using an image interpretation report related to a medical image. However, it is not necessary that the anatomy diagram generation apparatus of the present invention is applied to a case of using an image interpretation report in which a result of image diagnosis (diagnosis using images) is recorded. Alternatively, the anatomy diagram generation apparatus of the present invention may be applied to generation of an anatomy diagram from various reports related to medical treatment, such as a report in which a result of diagnosis by using a method other than image diagnosis is recorded.

Further, various kinds of correspondence between the region or the like and the keywords, which were described in generation of an anatomy diagram from a three-dimensional human body model by using an image interpretation report related to a medical image, may be applied to the case of generating an anatomy diagram from the other kinds of report related to medical treatment.

In the above embodiment, a case of generating an anatomy diagram from a three-dimensional human body model in a healthy state was described. Further, a three-dimensional human body model affected by a specific disease may be prepared. Then, an anatomy diagram may be generated from one of the three-dimensional human body model in a healthy state and the three-dimensional human body affected by the specific disease. Alternatively, anatomy diagrams may be generated from both of the three-dimensional human body models.

Further, a four-dimensional human body model (a group of three-dimensional human body models, each representing a step of motion state) may be prepared in advance. In the four-dimensional human body model, it is possible to observe a motion state of a joint or the like. Further, an anatomy diagram may be generated from each of the three-dimensional human body models, which constitute the four-dimensional human body model, based on the keyword extracted from a report.

What is claimed is:

1. An anatomy diagram generation method comprising the steps of:
storing a multiplicity of keywords to be extracted from reports related to medical treatment, each of the multiplicity of keywords representing a region of a human body, a disease name, or a treatment method, and an image generation condition for volume rendering that is appropriate for the region of the human body, the disease name, or the treatment, which is represented by each of the multiplicity of keywords, in such a manner that each of the multiplicity of keywords and the image generation condition are correlated with each other;
extracting, from a report related to medical treatment of a patient, at least one of the multiplicity of keywords representing a region of a human body, a disease name, or a treatment method; and
generating an anatomy diagram by performing volume rendering on a three-dimensional image representing a three-dimensional human body model by using the image generation condition correlated with the at least one of the multiplicity of keywords, which has been extracted.

2. An anatomy diagram generation method, as defined in claim 1, wherein the image generation condition includes a range of volume rendering in the three-dimensional image and a viewpoint at the time of volume rendering.

3. An anatomy diagram generation method, as defined in claim 1, wherein a line diagram is generated from the generated anatomy diagram.

4. An anatomy diagram generation method, as defined in claim 2, wherein a line diagram is generated from the generated anatomy diagram.

5. An anatomy diagram generation method, as defined in claim 2, wherein the range of volume rendering includes a target region corresponding to the region of the human body, the disease name or the treatment method represented by the at least one of the multiplicity of keywords, which has been extracted, and a surrounding region that is other than the target region, and
wherein the volume rendering is performed in such a manner that the opacity of the surrounding region is lower than the opacity of the target region.

6. An anatomy diagram generation apparatus comprising:
a storage unit that stores a multiplicity of keywords to be extracted from reports related to medical treatment, each of the multiplicity of keywords representing a region of a human body, a disease name, or a treatment method, and an image generation condition for volume rendering that is appropriate for the region of the human body, the disease name, or the treatment, which is represented by each of the multiplicity of keywords, in such a manner that each of the multiplicity of keywords and the image generation condition are correlated with each other;
an extraction unit that extracts, from a report related to medical treatment of a patient, at least one of the multiplicity of keywords representing a region of a human body, a disease name, or a treatment method; and
an image generation unit that obtains, from the storage unit, the image generation condition correlated with the at least one of the multiplicity of keywords extracted by the extraction unit, and generates an anatomy diagram by performing volume rendering on a three-dimensional image representing a three-dimensional human body model by using the obtained image generation condition.

7. An anatomy diagram generation apparatus, as defined in claim 6, wherein the image generation condition includes a range of volume rendering in the three-dimensional image and a viewpoint at the time of volume rendering.

8. An anatomy diagram generation apparatus, as defined in claim 6, wherein the image generation unit generates a line diagram from the generated anatomy diagram.

9. An anatomy diagram generation apparatus, as defined in claim 7, wherein the image generation unit generates a line diagram from the generated anatomy diagram.

10. An anatomy diagram generation apparatus, as defined in claim 7, wherein the range of volume rendering includes a target region corresponding to the region of the human body, the disease name or the treatment method represented by the at least one of the multiplicity of keywords, which has been extracted, and a surrounding region that is other than the target region, and
wherein the image generation unit performs the volume rendering in such a manner that the opacity of the surrounding region is lower than the opacity of the target region.

11. A non-transitory computer-readable medium storing therein a program for causing a computer to execute processing for generating an anatomy diagram, the program comprising the procedures of:
storing a multiplicity of keywords to be extracted from reports related to medical treatment, each of the multiplicity of keywords representing a region of a human body, a disease name, or a treatment method, and an image generation condition for volume rendering that is appropriate for the region of the human body, the disease name, or the treatment, which is represented by each of the multiplicity of keywords, in such a manner that each of the multiplicity of keywords and the image generation condition are correlated with each other;
extracting, from a report related to medical treatment of a patient, at least one of the multiplicity of keywords representing a region of a human body, a disease name, or a treatment method; and
generating an anatomy diagram by performing volume rendering on a three-dimensional image representing a three-dimensional human body model by using the image generation condition correlated with the at least one of the multiplicity of keywords, which has been extracted.

12. A non-transitory computer-readable medium, as defined in claim 11, wherein the image generation condition includes a range of volume rendering in the three-dimensional image and a viewpoint at the time of volume rendering.
